(19) United States
(12) Patent Application Publication
(10) Pub. No.: US 2025/0089932 A1
(43) Pub. Date: Mar. 20, 2025

(54) COFFEE MAKER AND HEATING CONTROL SYSTEM THEREOF

(71) Applicant: Tsann Kuen (Zhangzhou) Enterprise Co., Ltd., Zhangzhou (CN)

(72) Inventors: Yafei HAN, Zhangzhou (CN); Zheyuan Zheng, Zhangzhou (CN)

(21) Appl. No.: 18/805,600

(22) Filed: Aug. 15, 2024

(30) Foreign Application Priority Data
Sep. 14, 2023 (CN) 202311185203.8

(51) Int. Cl. A47J 31/54; A23F 5/26; A47J 31/46; A47J 31/52

(52) U.S. Cl. CPC A47J 31/545; A23F 5/262; A47J 31/468; A47J 31/5253; A47J 31/5255

(57) ABSTRACT

A heating control system for a coffee maker consists of a water tank, a water pump, a heating element, a temperature detecting member, and a control module. The water pump is connected to the water tank and the heating element and is configured to pump water from the water tank to the heating element for heating. The heating element is configured to heat the water to output at least one of hot water or steam. The temperature detecting member is configured to detect an output temperature of the heating element. The control module is configured to control the water pump and the heating element based on the temperature detecting member.

### RELATED APPLICATIONS

This application claims priority to Chinese patent application number 202311185203.8, filed on Sep. 14, 2023. Chinese patent application number 202311185203.8 is incorporated herein by reference.

### FIELD OF THE DISCLOSURE

The present disclosure relates to a heating control system and in particular a heating control system for a coffee maker.

### BACKGROUND OF THE DISCLOSURE

Existing atmospheric coffee machines on the market broadly comprise a housing, a water tank, a flow meter, a water pump, an air pump, a heating element, and a brewing chamber. The water tank, the flow meter, the water pump, the air pump, and the heating element are all arranged in the housing. The water pump is connected to the water tank and the heating element, and the flow meter is used for detecting a flow rate of water pumped by the water pump to the heating element. The brewing chamber is placed with a receiving vessel that can hold coffee powder, or the brewing chamber can be a coffee capsule, and a water outlet of the heating element is connected to the brewing chamber.

In a brewing process, the water pump pumps the water in the water tank to the heating element, the heating element heats the water into hot water, and the hot water is then injected into the brewing chamber to extract and output coffee liquid from the coffee powder in the brewing chamber. After extraction is completed, the water will remain in the heating element and the brewing chamber, and the air pump is used to blow the air for drying.

As a result, the coffee machines require the flow meters and air pumps, which also indirectly increase the production costs.

### BRIEF SUMMARY OF THE DISCLOSURE

The object of the present disclosure is to overcome the above-mentioned shortcomings in the existing techniques and provide a coffee maker and a heating control system thereof.

In order to solve the above technical problems, the present disclosure provides a heating control system for a coffee maker consisting of a water tank, a water pump, a heating element, a temperature detecting member, and a control module.

The water pump is connected to the water tank and the heating element and is configured to pump water from the water tank to the heating element for heating. The heating element is configured to heat the water to output at least one of hot water or steam. The temperature detecting member is configured to detect an output temperature of the heating element. The control module is configured to control the water pump and the heating element based on the temperature detecting member.

A method of the control module controlling the water pump and the heating element based on the temperature detecting member comprises steps of: maintaining a heating power of the heating element at a first fixed value, obtaining an integral flow rate by integrating a flow rate of the water pumped by the water pump, and controlling the water pump to stop pumping when the integral flow rate reaches a predetermined flow rate.

In a preferred embodiment, the method of the control module controlling the water pump and the heating element based on the temperature detecting member further comprises steps of controlling a pumping power of the water pump according to the output temperature detected by the temperature detecting member.

In a preferred embodiment, controlling the pumping power of the water pump comprises controlling the water pump with different voltages to work at different powers.

In a preferred embodiment, controlling the pumping power of the water pump further comprises controlling the pumping power of the water pump to increase when the output temperature is higher than a preset temperature, controlling the pumping power of the water pump to decrease when the output temperature is lower than the preset temperature, and controlling the pumping power of the water pump to be maintained at a second fixed value when the output temperature is equal to the preset temperature.

In a preferred embodiment, the different voltages are voltages in different pulse forms per unit time.

In a preferred embodiment, the water pump is a water diaphragm direct current (DC) pump. An integral calculation of the flow rate pumped by the water pump during a working process of the water pump comprises integrating the flow rate of the water pumped by the water pump over a specific duration when the water pump works at different duty cycles, and flow data of the flow rate of the water pumped by the water pump is stored in the control module.

The present disclosure provides a heating control system for a coffee maker consisting of a water tank, a water pump, a heating element, a temperature detecting member, and a control module.

The water pump is connected to the water tank and the heating element and is configured to pump water from the water tank to the heating element for heating. The heating element is configured to heat the water to output at least one of hot water or steam. The temperature detecting member is configured to detect an output temperature of the heating element. The control module is configured to control the water pump and the heating element based on the temperature detecting member.

A method of the control module controlling the water pump and the heating element based on the temperature detecting member comprises steps of: maintaining a pumping power of the water pump at a first fixed value, obtaining an integral flow rate by integrating a flow rate of the water pumped by the water pump, and controlling the water pump to stop pumping when the integral flow rate reaches a predetermined flow rate.

In a preferred embodiment, the method of the control module controlling the water pump and the heating element based on the temperature detecting member further comprises steps of controlling a heating power of the heating element according to the output temperature detected by the temperature detecting member.

In a preferred embodiment, controlling the heating power of the heating element further comprises controlling the heating power of the heating element to decrease when the output temperature is higher than a preset temperature, controlling the heating power of the heating element to increase when the output temperature is lower than the preset temperature, and controlling the heating power of the heating element to be maintained at a second fixed value when the output temperature is equal to the preset temperature.

In a preferred embodiment, the water pump is a water diaphragm direct current (DC) pump. An integral calculation of the flow rate pumped by the water pump during a working process of the water pump comprises integrating the flow rate of the water pumped by the water pump over a specific duration when the water pump works at different duty cycles, and flow data of the flow rate of the water pumped by the water pump is stored in the control module.

The present disclosure provides a heating control system for a coffee maker consisting of a water tank, a water pump, a heating element, a temperature detecting member, and a control module.

The water pump is connected to the water tank and the heating element and is configured to pump water from the water tank to the heating element for heating. The heating element is configured to heat the water to output at least one of hot water or steam. The temperature detecting member is configured to detect an output temperature of the heating element. The control module is configured to control the water pump and the heating element based on the temperature detecting member.

A method of the control module controlling the water pump and the heating element based on the temperature detecting member comprises steps of: for a first duration, fixing a heating power of the heating element, controlling a pumping power of the water pump according to the output temperature detected by the temperature detecting member, and obtaining a first predetermined flow rate by integrating a flow rate of the water pumped by the water pump; for a second duration, fixing the pumping power of the water pump, controlling the heating power of the heating element according to the output temperature detected by the temperature detecting member, and obtaining a second predetermined flow rate by integrating the flow rate of the water pumped by the water pump; and controlling the water pump to stop pumping when a sum of the first predetermined flow rate and the second predetermined flow rate reaches a predetermined flow rate.

In a preferred embodiment, controlling the pumping power of the water pump further comprises controlling the pumping power of the water pump to increase when the output temperature is higher than a preset temperature, controlling the pumping power of the water pump to decrease when the output temperature is lower than the preset temperature, and controlling the pumping power of the water pump to be maintained at a first fixed value when the output temperature is equal to the preset temperature. Controlling the heating power of the heating element comprises controlling the heating power of the heating element to decrease when the output temperature is higher than the preset temperature, controlling the heating power of the heating element to increase when the output temperature is lower than the preset temperature, and controlling the heating power of the heating element to be maintained at a second fixed value when the output temperature is equal to the preset temperature.

In a preferred embodiment, the first duration is a first time period or a sum of a plurality of first time periods, and the second duration is a second time period or a sum of a plurality of second time periods.

The present disclosure provides a coffee maker comprising the heating control system and a brewing container, and the brewing container is configured to receive coffee powder.

The heating control system is in a hot water supply stage and a steam drainage stage in sequence.

In the hot water supply stage, the heating element is configured to supply the hot water, the brewing container is configured to receive the hot water to brew the coffee powder, and then a coffee liquid is output.

In the steam drainage stage, the heating element is configured to supply the steam, the brewing container is configured to receive the steam to discharge a residual coffee liquid.

In a preferred embodiment, the brewing container is a coffee capsule, or the brewing container is configured to receive the coffee capsule.

Compared with the existing techniques, the technical solution has the following advantages.

The coffee maker can realize a function of supplying water with the predetermined flow rate only through the water pump. The control module performs an integral calculation of the flow rate pumped by the water pump during a working process of the water pump, and the control module controls the water pump to stop pumping when the integral flow rate reaches the predetermined flow rate. The coffee maker no longer needs to use a flow meter to achieve flow control, and the coffee maker does not need to use an air pump to discharge residual water liquid, saving coffee maker production costs.

### BRIEF DESCRIPTION OF THE DRAWINGS

FIG. 1 shows a schematic diagram of a structure of a heating control system in the present disclosure.

FIG. 2 shows a flowchart of a method of a control module controlling a water pump and a heating element in Embodiment 1 of the present disclosure.

FIG. 3 shows a flowchart of a method of a control module controlling a water pump and a heating element in Embodiment 2 of the present disclosure.

### DETAILED DESCRIPTION OF THE EMBODIMENTS

The present disclosure will be further described below in conjunction with the accompanying drawings and embodiments.

### Embodiment 1

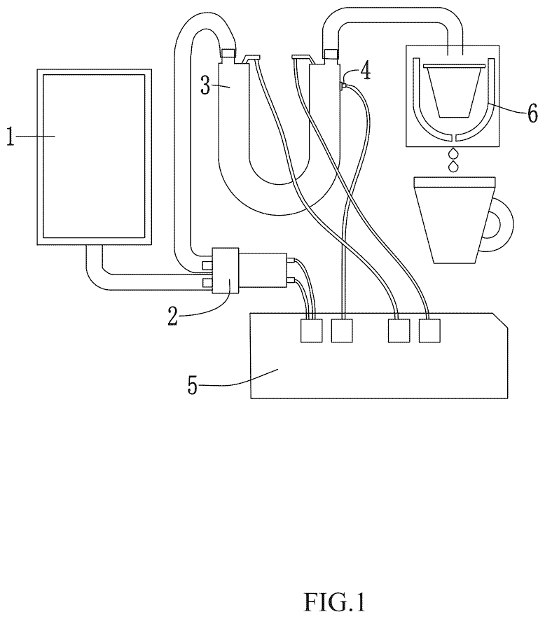

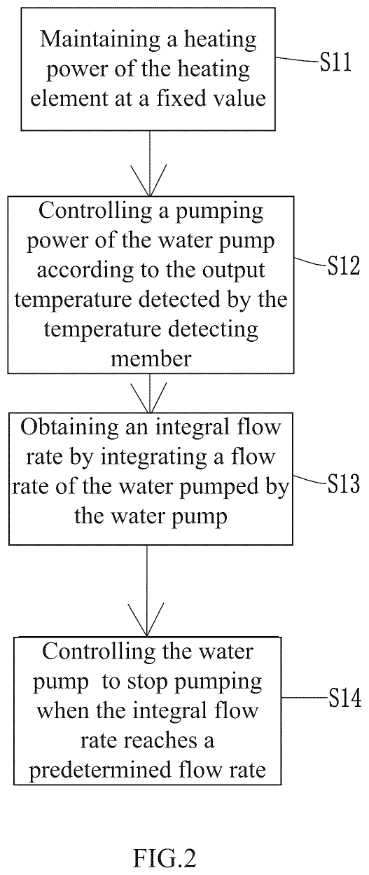

Referring to FIGS. 1 and 2, a coffee maker is provided. The coffee maker comprises a heating control system and a brewing container 6, and heating control system consists of a water tank 1, a water pump 2, a heating element 3, a temperature detecting member 4, and a control module 5. The water pump 2 is connected to the water tank 1 and the heating element 3, and the water pump 2 is configured to pump water from the water tank 1 to the heating element 3 for heating. The heating element 3 is configured to heat the water to output hot water or steam. The temperature detecting member 4 is configured to detect an output temperature of the heating element 3. The control module 5 is configured to control the water pump 2 and heating element 3 based on the temperature detecting member 4. A water outlet of the heating element 3 is connected to the brewing container 6, and the brewing container 6 is configured to receive coffee powder.

A method of the control module 5 controlling the water pump 2 and heating element 3 based on the temperature detecting member 4 comprises the steps of: S11: maintaining a heating power of the heating element 3 at a fixed value, S12: controlling a pumping power of the water pump 2 according to the output temperature detected by the temperature detecting member 4, S13: obtaining an integral flow rate by integrating a flow rate of the water pumped by the water pump 2, and S14: controlling the water pump 2 to stop pumping when the integral flow rate reaches a predetermined flow rate.

The coffee maker can realize a function of supplying the water with the predetermined flow rate only through the water pump 2. The control module 5 performs an integral calculation of the flow rate pumped by the water pump 2 during a working process of the water pump 2, and the control module 5 controls the water pump 2 to stop pumping when the integral flow rate reaches the predetermined flow rate. The coffee maker can achieve flow control without the need for a flow meter.

The brewing container 6 is configured to receive the coffee powder. In this embodiment, the brewing container 6 is configured to receive a coffee capsule.

Alternatively, the brewing container 6 can be a coffee capsule. The water outlet of the heating element 3 is connected to a top of the brewing container 6. When the water outlet of the heating element 3 discharges the hot water, an upper sealing film of the coffee capsule is punctured and the hot water is mixed with the coffee powder to form coffee liquid, which flows out of the brewing container 6 to a vessel or the like situated below the brewing container 6.

In this embodiment, controlling the pumping power of the water pump 2 comprises controlling the water pump with different voltages to work at different powers. The different voltages are voltages in different pulse forms per unit time, and a period and a frequency of the voltages in different pulse forms can be non-fixed. The voltages in different pulse forms can also be understood as working or pausing at a pulse with a specific duty cycle or a specific frequency, or the water pump 2 working in an ON/OFF time control mode.

Controlling the pumping power of the water pump 2 further comprises: controlling the pumping power of the water pump 2 to increase when the output temperature is higher than a preset temperature, controlling the pumping power of the water pump 2 to decrease when the output temperature is lower than the preset temperature, and controlling the pumping power of the water pump 2 to be maintained at a fixed value when the output temperature is equal to the preset temperature.

In this embodiment, the water pump 2 is a water diaphragm direct current (DC) pump. The integral calculation of the flow rate pumped by the water pump 2 during the working process of the water pump 2 comprises integrating the flow rate of water pumped by the water pump 2 over a specific duration when the water pump 2 works at different duty cycles. Flow data of the flow rate of the water pumped by the water pump 2 over the specific duration when the water pump 2 works at different duty cycles is stored in the control module 5.

Specifically, first, the coffee maker is measured and the flow rate of the water pumped by the water pump 2 within an effective duty cycle is calibrated. The higher the accuracy, the better. These values are applied to be tabulated on a program of the control module 5 and used for a water volume accumulation and integration operation. Integrating the flow rate of the water pumped by the water pump 2 over the specific duration when the water pump 2 works at different duty cycles can get a more accurate coffee cup volume, used in a cup volume setting. The water diaphragm DC pump is affected by a pressure in pipelines, and the water diaphragm DC pump needs some compensation for different actual water temperatures in order to get a more accurate cup volume.

In this embodiment, the heating control system can be in a hot water supply stage and a steam drainage stage in sequence. In the hot water supply stage, the heating element 3 supplies the hot water, and the brewing container 6 receives the hot water to brew the coffee powder to output the coffee liquid. In the steam drainage stage, the heating element 3 supplies the steam, and the brewing container 6 receives the steam, and then discharges a residual coffee liquid. In the steam drainage stage, moisture in the heating element 3 can be dried by the steam.

### Embodiment 2

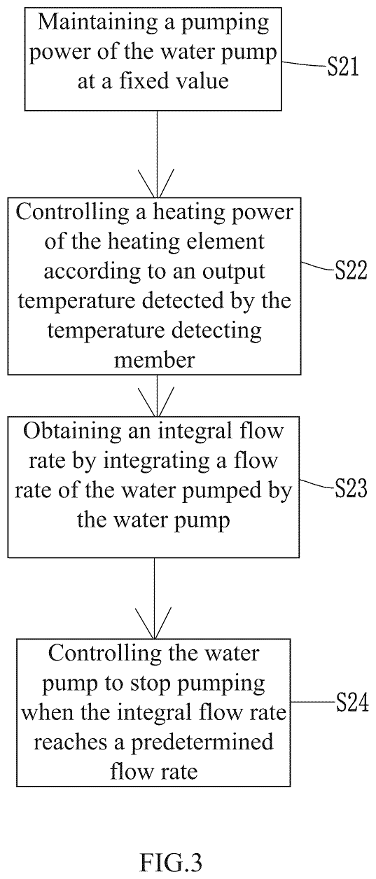

Referring to FIG. 3, the difference between this embodiment and Embodiment 1 is that a method of the control module 5 controlling the water pump 2 and the heating element 3 comprises the steps of: S21: maintaining a pumping power of the water pump 2 at a fixed value, S22: controlling a heating power of the heating element 3 according to an output temperature detected by the temperature detecting member 4, S23: obtaining an integral flow rate by integrating a flow rate of the water pumped by the water pump 2, and S24: controlling the water pump 2 to stop pumping when the integral flow rate reaches a predetermined flow rate.

Controlling the heating power of the heating element 3 further comprises: controlling the heating power of the heating element 3 to decrease when the output temperature is higher than a preset temperature, controlling the heating power of the heating element 3 to increase when the output temperature is lower than the preset temperature, and controlling the heating power of the heating element 3 to be maintained at a fixed value when the output temperature is equal to the preset temperature.

A water amount of water driven by the water pump 2 with a fixed pumping power is lower than a water amount parameter of a thermal balance when the heating element 3 is heated at full power.

$$α \times P \times t = m \times C \times Δ T = V \times t \times C \times Δ T$$

In the above equation, a is heating efficiency, P is heating rated power, and t is time.

In the above equation, m is mass of water, C is specific heat capacity of water, ΔT is temperature change of the water passing through the heating element, and V is water flow rate.

In the above equation, α×P×t represents an effective heating energy supplied by the heating element per unit time.

In the above equation, m×C×ΔT represents an energy absorbed (released) by a certain mass of water when its temperature is raised (lowered).

The equation can be simplified to α×P=V×C×ΔT

The simplified equation shows that in a balanced and stable state, the heating power of the heating element 3 will only act on heating the water. When a water flow rate through the heating element 3 remains unchanged, changing the heating power of the heating element 3 will directly change a temperature of the water at the water outlet of the heating element 3.

Therefore, the water amount of water driven by the water pump 2 with the fixed pumping power is lower than the water amount parameter of the thermal balance when the heating element 3 is heated at full power, which is more conducive to controlling the water temperature heated by the heating element 3.

### Embodiment 3

The difference between this embodiment and Embodiment 1 is that a method of the control module 5 controlling the water pump 2 and heating element 3 based on the temperature detecting member 4 comprises the steps as follow.

For a first duration, a heating power of the heating element 3 is maintained at a fixed value, a pumping power of the water pump 2 is controlled according to the output temperature detected by the temperature detecting member 4, and a first predetermined flow rate is obtained by integrating a flow rate of the water pumped by the water pump 2.

For a second duration, the pumping power of the water pump 2 is maintained at a fixed value, the heating power of the heating element 3 is controlled according to the output temperature detected by the temperature detecting member 4, and a second predetermined flow rate is obtained by integrating the flow rate of the water pumped by the water pump 2.

The water pump 2 is controlled to stop pumping when a sum of the first predetermined flow rate and the second predetermined flow rate reaches a predetermined flow rate.

Controlling the pumping power of the water pump 2 further comprises: controlling the pumping power of the water pump 2 to increase when the output temperature is higher than a preset temperature, controlling the pumping power of the water pump 2 to decrease when the output temperature is lower than the preset temperature, and controlling the pumping power of the water pump 2 to be maintained at the fixed value when the output temperature is equal to the preset temperature.

Controlling the heating power of the heating element 3 further comprises: controlling the heating power of the heating element 3 to decrease when the output temperature is higher than the preset temperature, controlling the heating power of the heating element 3 to increase when the output temperature is lower than the preset temperature, and controlling the heating power of the heating element 3 to be maintained at the fixed value when the output temperature is equal to the preset temperature.

In this embodiment, the first duration is a first time period or a sum of a plurality of first time periods. The second duration is a second time period or a sum of a plurality of second time periods. For example, a total heating time of the coffee maker is from a time point t0 to a time point t1, and there exists a time point t2 between t0 and t1. Then, a period between t0 and t2 can be defined as the first duration, and a period between t2 and t1 can be defined as the second duration, whereby both the first duration and the second duration are one time period. Alternatively, the total heating time of the coffee maker is from the time point t0 to the time point t1, and there exists time points t2, t3, and t4. Then, a period between t0 and t2 can be defined as a first period, a period between t2 and t3 can be defined as a second period, a period between t3 and t4 can be defined as a third period, and a period between t4 and t1 can be defined as a fourth period. A sum of the first period and the third period is the first duration, and the heating power of the heating element is fixed in the first duration. A sum of the second period and the fourth period is the second duration, and the pumping power of the water pump is fixed in the second duration.

The aforementioned embodiments are merely some embodiments of the present disclosure, and the scope of the disclosure is not limited thereto. Thus, it is intended that the present disclosure cover non-substantive modifications of the present disclosure provided they are made based on the concept within the technical scope disclosed in the present disclosure by any technical person skilled in the art.

What is claimed is:

1. A heating control system for a coffee maker consisting of:
a water tank,
a water pump,
a heating element,
a temperature detecting member, and
a control module, wherein:
the water pump is connected to the water tank and the heating element and is configured to pump water from the water tank to the heating element for heating,
the heating element is configured to heat the water to output at least one of hot water or steam,
the temperature detecting member is configured to detect an output temperature of the heating element,
the control module is configured to control the water pump and the heating element based on the temperature detecting member, and
a method of the control module controlling the water pump and the heating element based on the temperature detecting member comprises steps of:
maintaining a heating power of the heating element at a first fixed value,
obtaining an integral flow rate by integrating a flow rate of the water pumped by the water pump, and
controlling the water pump to stop pumping when the integral flow rate reaches a predetermined flow rate.

2. The heating control system for the coffee maker according to claim 1, wherein:
the method of the control module controlling the water pump and the heating element based on the temperature detecting member further comprises steps of:
controlling a pumping power of the water pump according to the output temperature detected by the temperature detecting member.

3. The heating control system for the coffee maker according to claim 2, wherein:
controlling the pumping power of the water pump comprises controlling the water pump with different voltages to work at different powers.

4. The heating control system for the coffee maker according to claim 3, wherein:
controlling the pumping power of the water pump further comprises:
controlling the pumping power of the water pump to increase when the output temperature is higher than a preset temperature,
controlling the pumping power of the water pump to decrease when the output temperature is lower than the preset temperature, and
controlling the pumping power of the water pump to be maintained at a second fixed value when the output temperature is equal to the preset temperature.

5. The heating control system for the coffee maker according to claim 3, wherein:
the different voltages are voltages in different pulse forms per unit time.

6. The heating control system for the coffee maker according to claim 2, wherein:
controlling the pumping power of the water pump further comprises:
controlling the pumping power of the water pump to increase when the output temperature is higher than a preset temperature,
controlling the pumping power of the water pump to decrease when the output temperature is lower than the preset temperature, and
controlling the pumping power of the water pump to be maintained at a second fixed value when the output temperature is equal to the preset temperature.

7. The heating control system for the coffee maker according to claim 1, wherein:
the water pump is a water diaphragm direct current (DC) pump,
an integral calculation of the flow rate pumped by the water pump during a working process of the water pump comprises integrating the flow rate of the water pumped by the water pump over a specific duration when the water pump works at different duty cycles, and
flow data of the flow rate of the water pumped by the water pump is stored in the control module.

8. A heating control system for a coffee maker consisting of:
a water tank,
a water pump,
a heating element,
a temperature detecting member, and
a control module, wherein:
the water pump is connected to the water tank and the heating element and is configured to pump water from the water tank to the heating element for heating,
the heating element is configured to heat the water to output at least one of hot water or steam,
the temperature detecting member is configured to detect an output temperature of the heating element,
the control module is configured to control the water pump and the heating element based on the temperature detecting member, and
a method of the control module controlling the water pump and the heating element based on the temperature detecting member comprises steps of:
maintaining a pumping power of the water pump at a first fixed value,
obtaining an integral flow rate by integrating a flow rate of the water pumped by the water pump, and
controlling the water pump to stop pumping when the integral flow rate reaches a predetermined flow rate.

9. The heating control system for the coffee maker according to claim 8, wherein:
the method of the control module controlling the water pump and the heating element based on the temperature detecting member further comprises steps of:
controlling a heating power of the heating element according to the output temperature detected by the temperature detecting member.

10. The heating control system for the coffee maker according to claim 9, wherein:
controlling the heating power of the heating element further comprises:
controlling the heating power of the heating element to decrease when the output temperature is higher than a preset temperature,
controlling the heating power of the heating element to increase when the output temperature is lower than the preset temperature, and
controlling the heating power of the heating element to be maintained at a second fixed value when the output temperature is equal to the preset temperature.

11. The heating control system for the coffee maker according to claim 8, wherein:
the water pump is a water diaphragm direct current (DC) pump,
an integral calculation of the flow rate pumped by the water pump during a working process of the water pump comprises integrating the flow rate of the water pumped by the water pump over a specific duration when the water pump works at different duty cycles, and
flow data of the flow rate of the water pumped by the water pump is stored in the control module.

12. A heating control system for a coffee maker consisting of:
a water tank,
a water pump,
a heating element,
a temperature detecting member, and
a control module, wherein:
the water pump is connected to the water tank and the heating element and is configured to pump water from the water tank to the heating element for heating,
the heating element is configured to heat the water to output at least one of hot water or steam,
the temperature detecting member is configured to detect an output temperature of the heating element,
the control module is configured to control the water pump and the heating element based on the temperature detecting member, and
a method of the control module controlling the water pump and the heating element based on the temperature detecting member comprises steps of:
for a first duration, fixing a heating power of the heating element, controlling a pumping power of the water pump according to the output temperature detected by the temperature detecting member, and obtaining a first predetermined flow rate by integrating a flow rate of the water pumped by the water pump,
for a second duration, fixing the pumping power of the water pump, controlling the heating power of the heating element according to the output temperature detected by the temperature detecting member, and obtaining a second predetermined flow rate by integrating the flow rate of the water pumped by the water pump, and
controlling the water pump to stop pumping when a sum of the first predetermined flow rate and the second predetermined flow rate reaches a predetermined flow rate.

13. The heating control system for the coffee maker according to claim 12, wherein:
controlling the pumping power of the water pump further comprises:
controlling the pumping power of the water pump to increase when the output temperature is higher than a preset temperature, controlling the pumping power of the water pump to decrease when the output temperature is lower than the preset temperature, and controlling the pumping power of the water pump to be maintained at a first fixed value when the output temperature is equal to the preset temperature, and
controlling the heating power of the heating element comprises:
controlling the heating power of the heating element to decrease when the output temperature is higher than the preset temperature, controlling the heating power of the heating element to increase when the output temperature is lower than the preset temperature, and controlling the heating power of the heating element to be maintained at a second fixed value when the output temperature is equal to the preset temperature.

14. The heating control system for the coffee maker according to claim 12, wherein:
the first duration is a first time period or a sum of a plurality of first time periods, and
the second duration is a second time period or a sum of a plurality of second time periods.

15. A coffee maker, comprising:
the heating control system according to claim 1, and
a brewing container, wherein:
the brewing container is configured to receive coffee powder,
the heating control system is in a hot water supply stage and a steam drainage stage in sequence,
in the hot water supply stage, the heating element is configured to supply the hot water, the brewing container is configured to receive the hot water to brew the coffee powder, and then a coffee liquid is output, and
in the steam drainage stage, the heating element is configured to supply the steam, and the brewing container is configured to receive the steam to discharge a residual coffee liquid.

16. The coffee maker according to claim 15, wherein:
the brewing container is a coffee capsule, or
the brewing container is configured to receive a coffee capsule.
